(19) United States
(12) Patent Application Publication
(10) Pub. No.: US 2023/0294050 A1
(43) Pub. Date: Sep. 21, 2023

(54) High Pressure Homogenizer

(71) Applicant: NETZSCH-Feinmahltechnik GmbH, Selb (DE)

(72) Inventors: Udo Enderle, Arzberg (DE); Holger Moeschl, Selb (DE); Lars-Peter Weiland, Schönwald (DE)

(21) Appl. No.: 18/000,779

(22) PCT Filed: Jun. 1, 2021
(86) PCT No.: PCT/DE2021/000104

§ 371 Date: Mar. 31, 2023

(30) Foreign Application Priority Data
Jun. 5, 2020 (DE) 10 2020 003 401.2

(51) Int. Cl. B01F 25/60; F16J 15/44; B01F 23/50; F04B 15/02; F04B 53/08

(52) U.S. Cl. CPC B01F 25/60; F16J 15/44; B01F 23/59; F04B 15/02; F04B 53/08; B01F 2215/0468; B01F 2215/0431; B01F 2035/351

(57) ABSTRACT

A high pressure homogenizer for flowable substances charged with particles, having a high pressure chamber and a homogenizer unit that is located fluidically downstream thereof and, by swirling, expands the fluid to be homogenized which has previously been brought to a pressure of more than 500 bar in the high pressure chamber, and a plunger pump associated with the homogenizer unit, the plunger of which plunger pump pressurizes the high pressure chamber, wherein the high pressure homogenizer has a low pressure chamber which surrounds the plunger shaft to cool the plunger and which has an operating pressure of P_{N}≤25 bar, wherein the low pressure chamber and the high pressure chamber are separated from each other by a seal which is penetrated by the plunger, the seal being a throttle gap which is formed between the plunger shaft and a bushing that does not contact the plunger shaft, the ratio S/_{L} of the length to the radial annular gap height of the throttle gap being ≤0.0015.

### TECHNICAL FIELD

The invention relates to a high pressure homogenizer for flowable substances charged with particles according to the disclosure.

### BACKGROUND

In homogenization, the particles of a suspension are distributed as uniformly as possible, that is, homogeneously. For this purpose, the fluid that is to be homogenized is pumped in a homogenizer under pressure by a homogenizer unit. In the homogenizer unit, turbulences are generated in association with selected shearing forces as well as cavitation, in order to separate agglomerated particles within the fluid that is to be homogenized.

So-called plunger pumps are frequently used to pump the fluid into the homogenizer unit. Plunger pumps are displacement pumps in which the piston rod, the so-called plunger, itself constitutes the piston. The piston does not extend as far as the cylinder wall. Therefore, no seal is required between the enclosing surface of the piston and the cylinder wall. With a plunger pump, a seal is required—situated as a rule at the entrance to the working space—between the working space and the plunger.

To protect the plunger pump from overheating during operation, it is a common practice to provide cooling for the plunger. Investigations into this matter have already revealed that the fluid that is to be homogenized can be used to cool the plunger.

For this purpose, the plunger can be fed through a cooling chamber. Because the plunger is primarily heated in the area that is situated in the working space during operation, the cooling chamber should be directly contiguous with the pump working space. Cooling of the plunger close to the heat producing zone is thereby guaranteed. Using the fluid that is to be homogenized as the cooling agent is an obvious choice. The fluid is thereby pumped through the cooling chamber before it reaches the working space of the plunger pump. It thereby flows around the plunger, so that said plunger becomes cooled. On exiting the cooling chamber, the fluid, finally, is advanced onward into the working space.

Because high pressures are expected to be generated in the working space, sufficient insulation of the working space must be provided from the environment, as well as from the cooling chamber. For this purpose, use is generally made of seals that are in contact with the plunger. Because of the motion of the plunger, this results in abrasion of the seal, particularly from pumping of fluids containing solid particles. In addition, seals of this type are frequently expensive to install, as they must usually be mounted in a pre-stressed state in order to minimize relative motions of the seal and of the housing surrounding the seal.

In view of such considerations, it is the purpose of the invention to provide a high pressure homogenizer by means of which the abrasion occurring between the working space and the cooling chamber can be reduced.

### SUMMARY

According to the invention, this problem is solved thanks to the characteristics of the principal claims based on the high pressure homogenizer.

The solution of the problem is based on a high pressure homogenizer for fluid materials bearing solid particles (sometimes abbreviated here as “particles”), having at least one high pressure chamber and at least one homogenizer unit that is located fluidically downstream thereof. The homogenizer unit serves to expand the fluid to be homogenized, which in most cases has a viscosity of 20 mPas and more and has previously been brought to a pressure of more than 500 bar in the at least one high pressure chamber by complete or essentially complete swirling of the fluid. The homogenizer unit is accordingly equipped for this purpose.

The high pressure homogenizer, in addition, comprises a plunger pump which is associated with the homogenizer unit and whose at least one plunger places the high pressure chamber under pressure. The high pressure homogenizer thus possesses a low pressure chamber, surrounding the plunger shaft, to cool the plunger. The low pressure chamber exerts an operating pressure of P_{N}≤25 bar. The low pressure chamber and the high pressure chamber in this case are separated from each other by a seal which is penetrated by the plunger. The inventive high pressure homogenizer is distinguished in that the seal which is penetrated by the plunger is a throttle gap which is formed between the plunger shaft and a preferably rigid bushing that does not contact the plunger shaft (or essentially does not contact it, barring any perceptible disadvantage). For the length (L) and radial annular gap height (S) of the throttle gap, the ratio S/L is ≤0.0015. The term “length” (L) designates in this context the so-called cylindrical length. This refers to the length over which the annular gap height—apart from unavoidable shape tolerances—is cylindrical, so that the entry and exit areas of the gap which constitute a bevel or a radius are not included in the calculation.

The inventive configuration results in a series of advantages.

The complete or essentially complete expansion of the fluid in the homogenizer unit has the result that accumulations of solid particles in the fluid are separated from one another and distributed essentially uniformly in the fluid.

The advantage of the plunger pump used here for feeding the homogenizer unit consists, in particular, in the fact that it generates pulsations in the fluid stream pumped toward the homogenizer unit, pulsations which help to further improve the effectiveness of the homogenization. The plunger pump in this case can include either only one powered plunger or else several powered plungers—preferably with staggered dead points. The latter option, in certain cases, has the advantage that the pulsations' frequency increases and at the same time their solidity-critical amplitude is reduced.

The advantage of a plunger pump equipped with several plungers consists in the fact that the fluid to be homogenized can be fed to the homogenizer unit continuously rather than in spurts.

For this purpose, the plungers must be powered merely in such a way that in each case they reach their lower dead point non-simultaneously with the other plungers.

Because the plunger shaft of the at least one plunger extends through the lower pressure chamber of the plunger pump, it is surrounded by the fluid that is to be homogenized. This reduces the warming of the plunger, which is unavoidable during the pumping process, and thus results in an increase in the pump's performance capacity.

The seal between the high pressure and low pressure chambers operates without contact, to a substantial extent in all cases, and preferably even completely.

The seal is well lubricated thanks to the unavoidable leakage flow. Depending on the viscosity of the fluid, the leakage occurs at least as a trailing leakage, but as a rule as variable-pressure-driven gap leakage. The leakage flow in this case is negligible, because the leakage flow emerging from the high pressure chamber is collected in the low pressure chamber and finally fed back into the high pressure chamber.

The invention overcomes the preconception that a gap seal with very low gap height cannot be considered a possibility for sealing a particle-bearing fluid, because, with the pressure difference discussed here, problems can be expected quite soon owing to accumulation of the solid particles conveyed into the gap with the fluid.

A surprising occurrence with the gap configuration discussed here is that no harmful accumulation of solid particles occurs in the gap as a rule. Owing to the oscillating motion of the plunger in the seal, the seal gap is kept sufficiently active.

Instead of the term “high pressure homogenizer,” the term “disperser” can also be employed.

The term “plunger” designates a piston that is constituted by the piston rod.

The term “high pressure chamber” designates the working space of the plunger pump.

The term “cooling chamber” designates the low pressure space of the plunger pump.

The designation “non-contacting seal” in this context refers to the contact of the bushing of the high pressure seal with the enclosing surface of the plunger. Contact of the high pressure seal with other components of the plunger pump is thus not excluded.

The designation “located fluidically downstream” refers to the fact that the fluid that is to be homogenized flows outward from the high pressure chamber all the way to the homogenizing unit.

There are a series of possible ways of configuring the invention so that its effectiveness or usefulness is improved even further.

Thus, it is particularly preferred that the cylindrical length (L) of the throttle gap—without including its front-end bevels or roundings—is equal to at least ⅔ of the diameter of the plunger. Ideally, the cylindrical length corresponds to at least the entire diameter of the plunger.

As a result of such a gap length, throttling of the flow speed of the leakage stream is ensured. This ensures not only that no excessively great leakage amount flows into the low pressure chamber, but also that problems, such as foaming upon the leakage's entry into the low pressure chamber, are prevented.

In an additional preferred embodiment, the annular gap height of the throttle gap is equal to at most 0.03 mm. To illustrate this in great detail, it is possible to state that, with particularly preferred embodiments of the invention, the bushing (with its tolerance taken into account) ought to have a slight inner diameter of 20 mm+0.009 mm and the plunger (with its tolerance taken into account) a maximum outer diameter of 20 mm-0.02 mm, but at present that is not pressing.

Investigations with gap heights of that kind have resulted in positive results with respect to the degree of the pump's effectiveness.

Ideally, the front end of the bushing on its side facing the high pressure chamber leads through a bevel to the inner enclosing surface of the bushing. The bevel is preferably configured as a flat bevel having a bevel angle of approximately or precisely 30 degrees or less, measured with respect to the longitudinal axis of the plunger. A flat bevel of this kind prevents or reduces the hard collisions of the piston on the bushing wall in cases in which the plunger moves from its central position during operation.

It has proved particularly favorable to mount an angled bevel. Such a bevel, on its side facing the high pressure chamber, consists of a first, steeper portion, which forms a 45-degree angle to the longitudinal axis of the bushing. On the side facing the seal gap, connected to this first portion there is a second bevel section having a flatter bevel angle, preferably of about or precisely 30 degrees or less. A bevel configured in this way keeps the solid particles as much as possible away from the seal bevel.

Ideally, on its side facing the plunger drive, the front end of the bushing (also) continues by way of a bevel to the inside enclosing surface of the bushing. This bevel is in most cases of steeper configuration than its counterpart on the side of the high pressure chamber.

Because the gap height configured between the plunger and the bushing is very small, there is a risk of damaging the bushing during installation of the plunger. A radius or edge or bevel on the front side of the bushing, the point from which the plunger is introduced into the bushing, reduces the risk of damage.

It is precisely because of a flat bevel that the intermittent development of leakage is further reduced, because its contrary lagging effect toward the high pressure chamber is encouraged as soon as the plunger moves deeper into the high pressure chamber.

As an alternative to the bevel, a radius r can be foreseen on the relevant position of the bushing.

The “side facing the plunger drive” here designates the side oriented toward the drive piston.

The bushing and the plunger preferably are constructed of materials with different thermal expansion coefficients.

The thermal expansion coefficients in this case are ideally more than merely marginally distinct from one another. If, for instance, the plunger is of ceramic material and the bushing of steel, this results in self-regulation of the seal gap. At unfavorable friction conditions, caused, for instance, by excessive particle deposit in the gap, friction heat occurs in the gap. Because of the friction heat in connection with varying heat expansion coefficients of the bushing and plunger, the seal gap in this case tends to grow. The result is that the gap is again freely flushed, countering the potential risk of damage caused by friction.

In another preferred embodiment, the plunger is of ceramic construction.

This is advantageous because ceramic materials have a high resistance to abrasion, heat, and pressure.

Thus, the plunger is preferably of massive ceramic construction.

In an additional preferred embodiment, the bushing is made of bearing metal.

It thus becomes possible to avoid damage resulting from occasional occurrence of direct friction contact between the enclosing surface of the plunger and the inner surface of the bushing (such as caused by impact incidence or from the impact of fluid currents).

Particularly advantageous, in addition, is the fact that the combination of the bushing and the plunger can be selected in such a way that it can compensate for differential processing temperatures, either to an essential extent or in any case partially. This can be explained by the following examples: If the processing temperature rises, then the fluid that is to be homogenized begins to reach a higher temperature. It tends to become thinner and more flowing. In the case of a very narrow seal gap between the bushing and the plunger, this could lead to lubrication problems and even in some cases erosion. Such effects can be reduced if the seal gap can modify its gap height by means of the pairing of different materials for the bushing and the plunger, so that lubrication is improved.

In a number of cases, a good option is for the bushing to be configured and mounted in such a way that at rising temperature it expands more strongly than the plunger. In such cases the expansion occurs in such a way that the height of the seal gap increases. Conversely, in other applications, it can be useful to pair the materials for the bushing and the plunger so that the seal gap at rising temperature is smaller.

Consequently, as already described, the seal gap is protected from damage caused by particle accumulations in the seal gap.

Ideally, the longitudinal axes of the bushing and of the plunger shaft moving back and forth in the bushing are aligned consistently parallel or preferably coaxially.

A uniform gap height of the seal gap between the bushing and the outer enclosure of the plunger shaft is thereby ensured.

It is advantageous to power each plunger by means of its own drive piston, associated only with it, which in turn is powered by a crank shaft. The drive pistons in this case are connected with the crank shafts by lift bearings, while the lift bearings are arranged at various angles surrounding the rotational axis of the crank shaft. A drive piston consequently assumes the role of a connection rod.

In another preferred embodiment, the plunger is connected by a cardan joint coupling with the drive piston that is powering it.

Transmission of the motion of the drive piston onto the plunger is thereby made possible, while the drive piston and plunger are simultaneously able to pivot relative to one another. As a result of the pivotability of the drive piston relative to the plunger, the plunger is impacted merely with axial forces and remains free of forces acting radially in the direction of the bushing. The motion of the plunger accordingly remains linear and essentially parallel to the longitudinal axis of the bushing.

Ideally, the front end of the plunger at the powering end, or the front end of the drive piston transmitting the power drive forces onto it, is convexly curved.

By means of a curvature of the mutually facing front ends of the plunger and of the drive piston, they can be contiguous with one another without blocking the pivotability of the drive piston in relation to the plunger.

### BRIEF DESCRIPTION OF THE DRAWINGS

Aspects and embodiments are now described, by way of example, with reference to the accompanying drawings, on which:

FIG. 1: illustrates a schematic depiction of an inventive high pressure homogenizer.

FIG. 2: illustrates an isometric view of a detail of the plunger pump (without the high pressure chamber).

FIG. 3: illustrates an enlarged detail from FIG. 2.

FIG. 4: illustrates an overhead view of the plunger pump (with the high pressure chamber not shown).

FIG. 5: illustrates sectional view A of a first embodiment of the plunger pump.

FIG. 6: illustrates sectional view B of a first embodiment of the plunger pump.

FIG. 7: illustrates partial sectional view of the first embodiment according to FIGS. 5 and 6.

FIG. 8: illustrates sectional view A of a second embodiment of he plunger pump, with bushing kept radially movable.

FIGS. 8a and 8b: illustration of the theoretical movability of the bushing with cylindrical outer enclosing surface.

FIGS. 8c and 8d: illustration of the theoretical movability of the bushing with spherical outer enclosing surface.

FIG. 9: illustrates sectional view A of a third embodiment of the plunger pump.

FIG. 10: illustrates sectional view A of a fourth and of a fifth embodiment of the plunger pump.

FIG. 11: illustrates detailed view of an inventive bushing.

### DETAILED DESCRIPTION

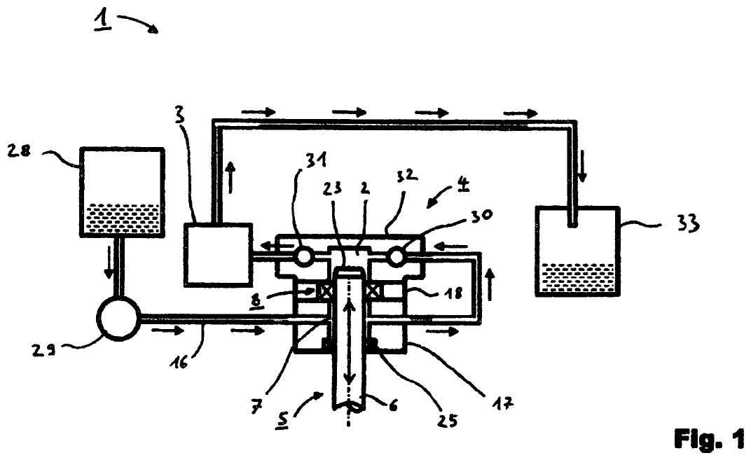

The mode of operation of the high pressure homogenizer is described hereinafter with reference to FIGS. 1 through 10.

The fundamental mode of operation of the high pressure homogenizer 1 can be clearly recognized in the schematic depiction in FIG. 1.

The fluid that is to be homogenized is first situated in the product supply container 28. From there it is conveyed with the help of the conveyor pump 29 through the conduits 16, first into the low pressure chamber 7 and then into the high pressure chamber 2.

In the high pressure chamber 2, high pressure is generated by means of penetration by the plunger 5. The said high pressure causes the inlet valve 30 to be closed and the outlet valve 31 to be opened. Then the plunger 5 is withdrawn again from the high pressure chamber 2, but only far enough so that the front end 23 of the plunger 5 remains situated inside the high pressure chamber 2. In this process, low pressure is generated in the high pressure chamber. This low pressure results in the closing of the outlet valve 31 and the opening of the inlet valve 30, so that once again fluid can stream into the high pressure chamber 2.

The high pressure chamber 2 is insulated from the environment and the low pressure chamber 7 by the seal 8 situated in the housing 18. The seal 8 here is arranged so that it surrounds the plunger 5. The difference in volume in comparison to the slight inner cross-section of the seal 8 is preferably 0.015 mm to 0.03 mm, ideally about 0.02 mm. This results in a radial gap height S between 0.075 mm and 0.015 mm. The gap should preferably be situated on a seal gap length L along the plunger longitudinal axis that corresponds to at least ⅔ of the plunger diameter. According to the invention, the relevant proportion is S/L≤0.0015 mm.

The plunger 5 with its plunger shaft 6 is fed through the housing 17 and the low pressure chamber 7 situated inside it. The fluid to be homogenized accordingly flows around the plunger shaft 6 inside the low pressure chamber 7, so that the shaft is cooled. Insulation of the low pressure 7 from the environment here occurs by means of the low pressure seal arrangement 25.

Ideally, several plungers are connected in a row. In the process, each of the individual plungers 5 is ideally controlled in such a way that they reach their lower dead point at different times rather than simultaneously.

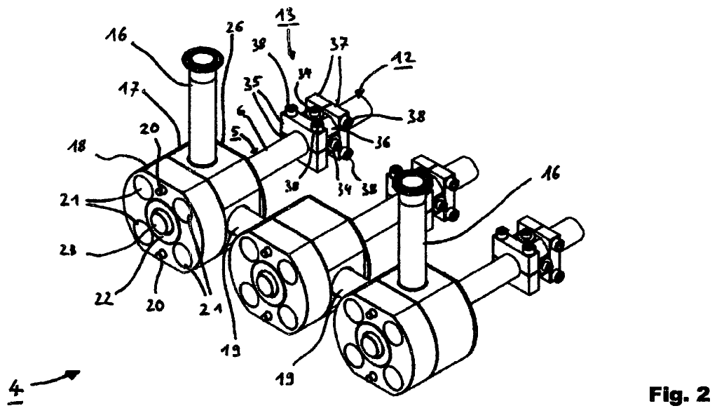

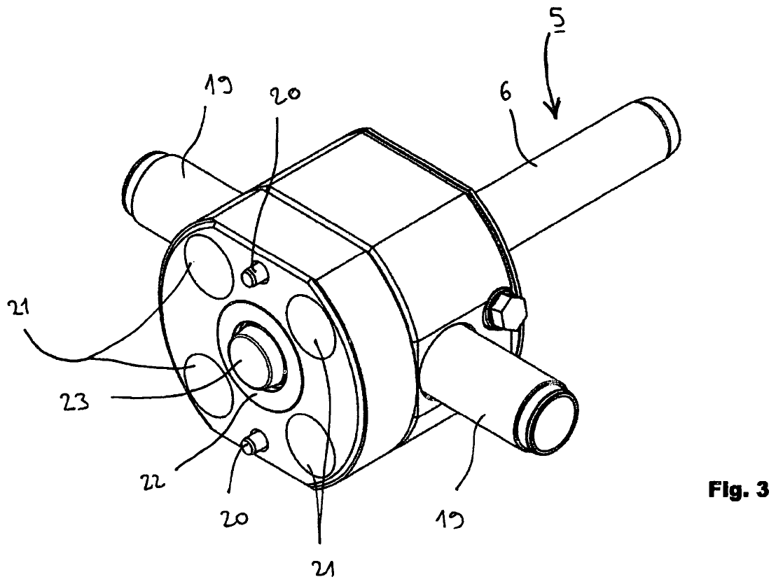

A plunger pump 4 of this type is shown in FIGS. 2 and 3. The high pressure chamber 2 or the housing 32 that constitutes the high pressure chamber 2 is not illustrated here.

For the sake of clarity, the individual components of the plunger pump 4 are provided with reference numbers only for one plunger 5 and the associated elements of the plunger pump 4.

Every plunger 5 of the plunger pump 4 is powered by one drive piston 12. The drive piston 12 and plunger 5 are connected with one another here by a radially flexible coupling, such as in the form of a cardan joint 13 that is not described here in detail.

The plunger 5 protrudes through the housing cover 26, the housing 17 that encloses or constitutes the low pressure chamber 7, as well as the housing 18 that surrounds the high pressure seal 8. The housing portion 32, which constitutes the high pressure chamber 2, which is not however shown in this FIG. 2 but rather in FIG. 1, is attached to the housing 18 that surrounds the high pressure seal 8.

To connect the individual housing portions with one another, boreholes 21 are provided for attachment screws. In addition, for purposes of exact positioning of the housing portion 32 on the housing portion 18, in each case two or more dowel pins 20 are installed on the housing portion 18.

The individual low pressure chambers 7 are connected with one another by the connecting conduits 19. The fluid that is to be homogenized is therefore transported by way of an inlet 16 into one of the low pressure chambers 7 and flows outward from there by way of the connecting conduits 19 through the other low pressure chambers 7. By way of the outlet 16, the fluid is finally conveyed out of the final low pressure chamber 7. From there it flows by way of a conduit, not illustrated, into the high pressure chambers 2, also not illustrated.

To connect a plunger 5 with a drive piston without the plunger being tipped by the power impact of the drive piston toward the bushing with which it configures the gap seal, a radially flexible coupling is ideally employed, as already briefly mentioned. This topic is further discussed at a later point.

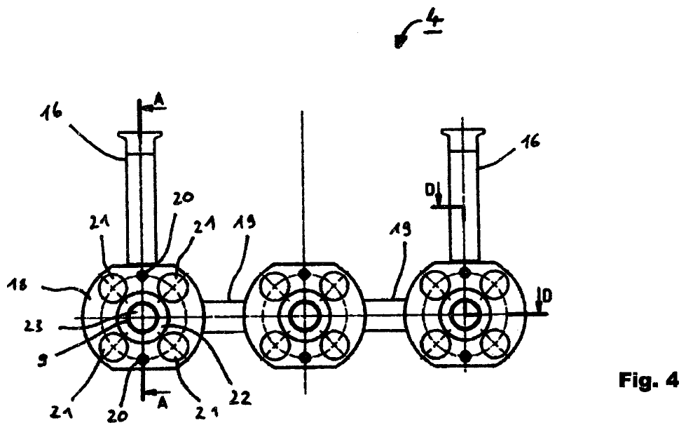

The arrangement of the plunger pump 4 is illustrated in the lower portion of FIG. 4. This view shows how the sectional lines A-A and D-D intersect the plunger pump 4.

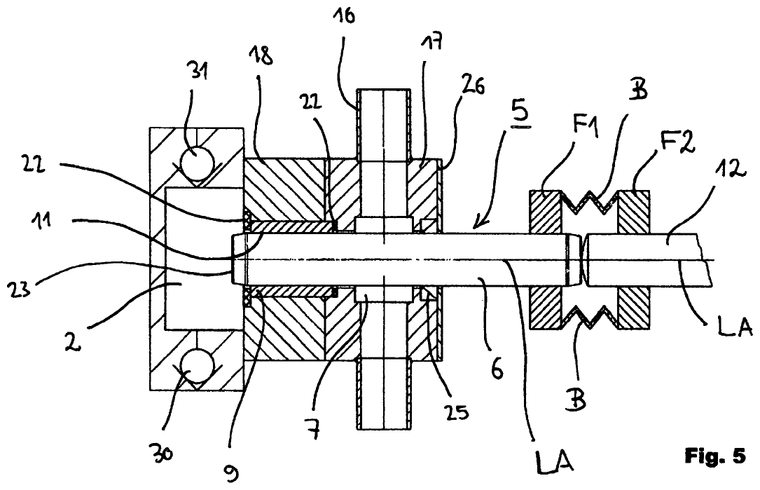

The sectional view of section A-A is depicted in FIG. 5. The high pressure chamber 2 in this case is indicated in a schematic manner.

The high pressure seal 8 for insulating the high pressure chamber 2 consists of two flat seals 22 as well as a first bushing 9. One of the flat seals 22 borders directly on the high pressure chamber 2, while the second flat seal 22 is contiguous with the housing 17. The flat seals, however, are only secondary seals for the bushings 9 and 24. The bushing 9 that surrounds the plunger shaft 6 is mounted between the two flat seals 22 and held axially.

In this embodiment, the bushing 9 is fixed directly and rigidly in the surrounding housing. In a number of cases, the installation occurs in such a way that the bushing is tensed in the radially inward direction at a pressure having the same order of magnitude as the pressure that attacks later in the seal gap and acts in the radially outward direction.

A radial seal gap, which cannot be distinguished in FIG. 5, is formed between the bushing 9 and the enclosing surface of the plunger shaft 6. Through the seal gap, a small quantity of the fluid to be homogenized that is situated in the high pressure chamber 2 can escape in the direction of the low pressure chamber 7. As a result of the ratio between seal gap height and seal gap length, the pressure continuously declines in the seal gap to the pressure in the low pressure chamber 7, which typically has a high pressure in the range of 3 bar. Most often the high pressure prevailing here is not situated above 6 bar. The ratio between the seal gap height and seal gap length is selected so that the leakage quantity is reduced while remaining great enough, however, to prevent friction problems with the particles possibly carried in the seal gaps and conveyed by the fluid.

On its front end 10 facing the drive piston 12, the bushing 9 comprises an edge 40 or a bevel or radius, through which the front end leads to the inner enclosing surface. This is intended to prevent the edge of the front end from chipping if it comes into contact in spurts with the plunger. In complementary manner, the plunger 5 can be equipped with a bevel 41.

Situated in the housing 17 is the low pressure chamber 7, through which the fluid to be homogenized flows and thereby cools the plunger 5 before it is conveyed to the high pressure chamber 2. The low pressure chamber 7 is insulated from the environment by the low pressure seal arrangement 25.

FIG. 5 likewise illustrates the essential technical aspects of a suitable radially flexible coupling.

As can be seen, the plunger 5 and the drive piston 12 are each held in place by a connection that is not characterized in greater detail. The two connections F1 and F2, as a rule, provide the plunger 5 and the drive piston 12 with a defined capacity to pivot with respect to one another. The connection, as can be seen, transmits the return stroke motion of the drive piston 12 to the plunger 5.

One of the front ends of the plunger 5 or of the drive piston 12 is of convex construction. Preferably it is the front end of the drive piston. Typically, it is constructed of the softer material.

In this manner the drive piston 12 can “shake off” certain amounts onto the plunger 5. Pivoting or lateral motions possibly performed by the drive piston 12 are not transmitted onto the plunger in this manner, so that the seal gap remains as undisturbed as possible. This is especially significant when the bushing 9 is built into the housing portion 18 surrounding it so as to be essentially radially immobile, as shown in FIG. 5.

In other words, the required pressure force in moving the plunger 5 into the high pressure chamber 2 is transmitted by the drive piston 12 onto the plunger 5. To ensure that the longitudinal axes of the plunger 5 and the bushing 9 always run coaxially during the pumping operation, the previously discussed radially flexible coupling is built in. It should be pointed out that the tractive force that is expected to move the plunger again in the direction of the drive piston 12 after reaching its lower dead point, is transmitted likewise by the drive piston 12 through the radially flexible coupling 13 onto the plunger 5.

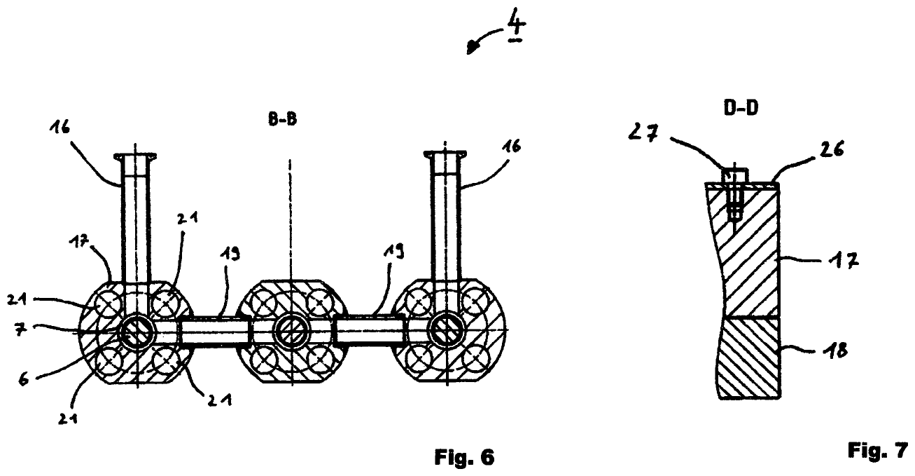

On the basis of the section line B-B shown in FIG. 6, it can be recognized how the low pressure chambers 7 are connected with one another by means of the connecting conduits 19.

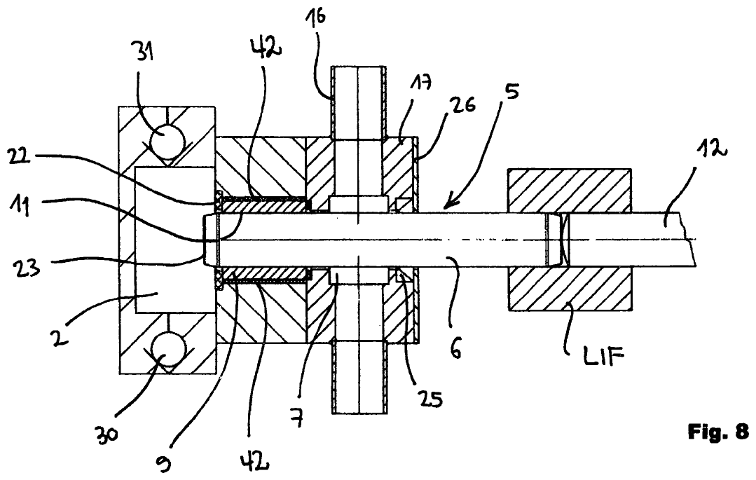

The section line D-D shown in FIG. 7 indicates how the housing cover 26 is secured by means of fixer screws 27 to the housing portion 17 that surrounds the low pressure chamber 7.

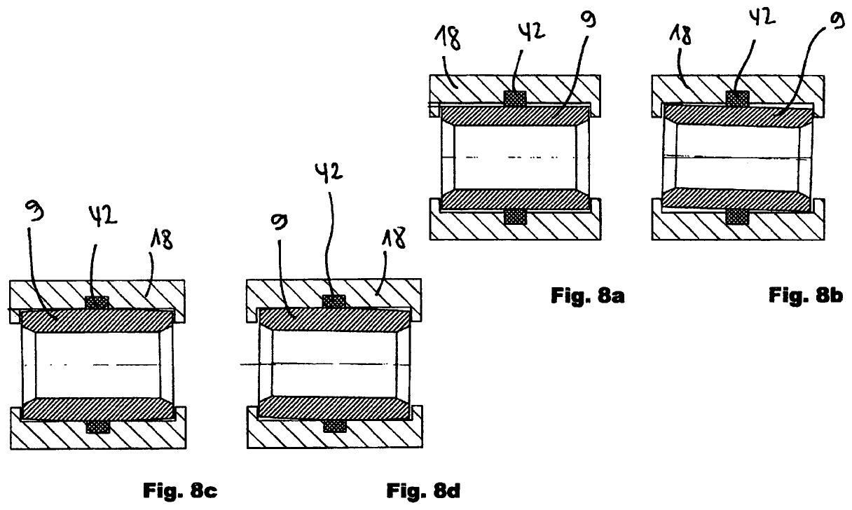

FIG. 8 presents a second embodiment of the invention.

Commentary made previously on the first embodiment applies here analogously, except for any differences made explicit hereinafter.

The first difference in comparison with the first embodiment consists in the fact that the bushing 9 that is part of the configuration of the seal gap is mounted in floating manner. For this purpose, on its outer periphery—at least in parts, preferably entirely—a bearing sleeve 42 is foreseen, made of more than only partially compressible material, ideally of a soft elastomer or rubber. The radial wall strength of the bearing sleeve 42 is typically less than that of the bushing 9, typically by a factor of at least 2. In all cases, the outer enclosure of the bushing 9 can also be spherical rather than ideally cylindrical. This enhances the pivotal mobility of the bushing 9 as the bearing sleeve 42 is reshaped.

The bearer sleeve 42 can be a discrete component in the form of a sleeve or one or more rings, or a casting compound secured in situ or rubber body vulcanized in situ.

A bearing sleeve 42 of this type allows the bushing 9 to move or pivot radial-translationally during operation by a certain amount. It can thus adjust itself on the plunger 5 so as to optimize the geometry of the seal gap from the viewpoint of insulation quality or insulation duration.

Other factors contributing to this pivotable capacity include the elastomer seal rings 22, which ensure secondary insulation and are contiguous with the front ends of the bushing 9. Unlike rigid retaining rings or shim washers, they do not clamp the front surfaces so tightly between themselves that the bushing 9 is prevented thereby from completing a possible pivot motion.

To help visualize the seal gap by pivoting of the bushing 9, FIGS. 8a and 8b illustrate this with a bushing with cylindrical outer enclosing surface, and FIGS. 8c and 8d show a bushing having spherical outer enclosing surface to illustrate how the pivoting of the bushing occurs.

Returning to FIG. 8, one can recognize that the second difference, independent of what was previously said, consists in the fact that the drive piston 12 and plunger 5 here are not connected with one another by means of a radial-flexible coupling, as FIG. 5 illustrated it previously, but rather by means of a rigid coupling. The reason for this is that in this case it is not absolutely necessary to divert the possible tipping motions of the drive piston of plunger 5. This necessity does not exist since in this embodiment the bushing 9 has the possibility to adjust to the current position of the plunger 5 on the basis of its flexible mounting; see once again FIG. 8. This also makes it possible to prevent the drive piston from transmitting disturbing cross-forces, which undermine the configuration of the gap geometry.

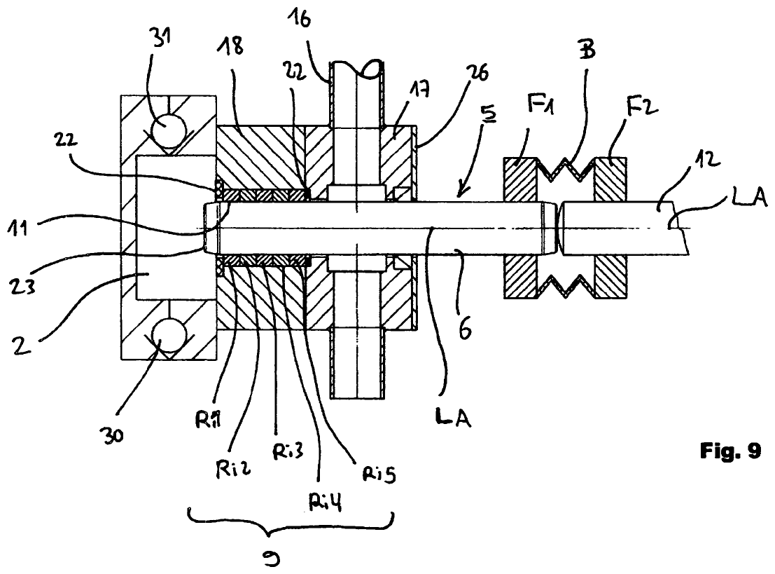

FIG. 9 shows a third embodiment of the invention.

Previous comments concerning the first embodiment also apply here analogously, unless explicitly indicated otherwise by the following difference.

The only difference from the first embodiment, as a rule, results from the fact that the bushing 9 is now of multi-part configuration. It consists now of several rings Ri1 to Ri5, ideally three, better at least four to eight rings, constructed directly one after another and in direct contact with one another. In this embodiment the rings are built in firmly in the housing portion 18 surrounding the high pressure seal. The division into individual rings considerably facilitates the assembly and disassembly during maintenance tasks.

In a number of different applications, it can also be very advantageous to achieve a succession of gap heights that are graduated between neighboring rings Ri1 through Ri5 so as to modify them not insignificantly. Thus, it is conceivable, for example, to configure the first ring, directly facing the high pressure chamber 2, with a lesser seal gap height than all or some of the following rings. In this way one can have the option of preventing the at least considerable penetration of particles into the seal gap which is actually equipped over its remaining length with a greater gap height.

An additional option with this solution is that the aforesaid first ring Ri1 realizes a sacrificial function: Because it has the smallest seal gap height, it breaks penetrating particles. It itself in this process undergoes increased abrasive wear. On the other hand, however, there is a reduction in the wear which the broken/pre-reduced particles cause to the other rings Ri2 through Ri5 or Rin, which configure the next seal gap, downstream of the leakage, with the greater seal gap height.

In most cases, the aforementioned rings Ri1 through Rin are endless in their peripheral direction. However, in a number of cases it is particularly favorable to divide them, that is, to construct them of several sections of ring arcs, although that is not separately shown here in the drawings. Such a division can be conducted in such a way as to make it possible to exchange the components that make up the bushing, without requiring any dismantling of the plunger.

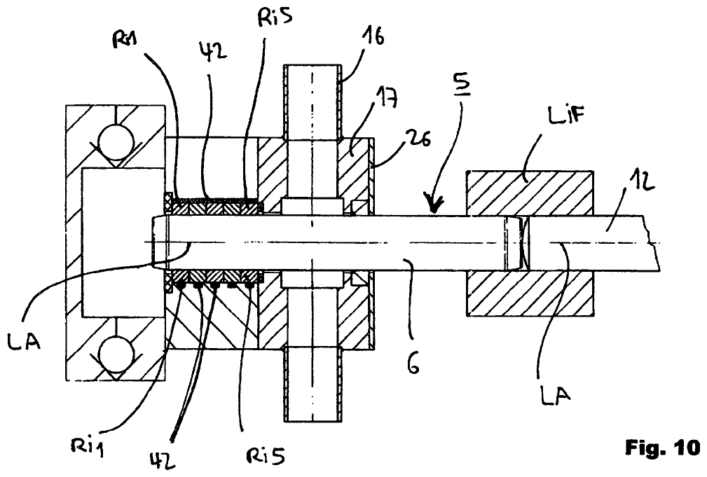

FIG. 10 shows a fourth and at the same time a fifth embodiment of the invention.

The preceding commentary concerning the first through third embodiments also applies here analogously, since these embodiments, in technical-functional terms, are a combination of the second and third embodiments.

The half of FIG. 10 depicted above the middle longitudinal axis illustrates the fourth embodiment. The bushing 9 is once again configured in multiple parts and consists preferably of the aforementioned number of rings Ri1 through Rin. Each of the rings, however, is now mounted elastically on its outer enclosing surface in such a way as was described above in the context of the second embodiment—such as by external casting with an elastomer mass or vulcanization into a rubber ring formed in situ or inserted into a common elastomer sleeve configured as a discrete component.

In this manner, every ring—at least to a great extent—is movable independently of the other rings. Thus, an especially good self-adjustment of the seal gap geometry can be achieved.

The half of FIG. 10 illustrated below the middle longitudinal axis LA depicts the fifth embodiment.

What's unusual here is that every ring has just one bearing sleeve associated with it alone. The bearing sleeve can, for instance—assuming availability of the necessary grooves—take the form of an O-ring, x-ring, or other standard component. Thus, the particular ring has on both sides, alongside its bearing sleever, freedom of movement with respect to the housing. This configuration enables an especially high degree of mobility or self-adjustment for the bushing 9.

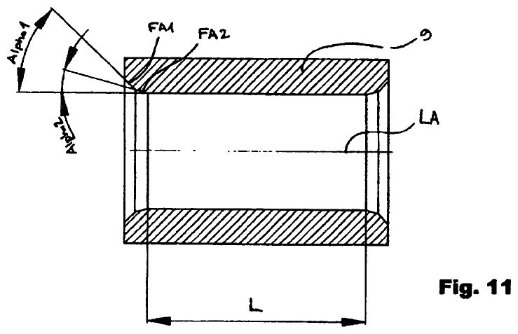

FIG. 11, finally, depicts a busing 9 in a detailed view. The angled bevel can be clearly recognized here. As can be seen, such a bevel mounted on the high pressure end consists of a first rather steep portion FA1. The latter forms a bevel angle Alpha 1 of 45 degrees or about 45 degrees to the longitudinal axis of the bushing. Attached to this first portion on the side facing the seal gap is a second bevel portion FA2 having a fairly flat bevel angle Alpha 2. The second bevel portion is preferably narrow enough so that no solid particles, or only a reduced number of them, can penetrate here. This reduces the impact of solid particles on the annular gap.

Such a bevel can also be mounted on the low pressure side.

Independently of the claims cited to this point, an option is also claimed for protection for a high pressure homogenizer in accordance with the principal claim, as well as in some cases in connection with one or more of the subsidiary claims, none of which comprises the low pressure chamber that surrounds a plunger shaft.

In addition, an option is also claimed for protection for the method performed with the high pressure homogenizer described in the context of this application as supported by a plunger pump with annular gap seal.

1. A high pressure homogenizer for fluid substances charged with particles, having a high pressure chamber and a homogenizer unit that is located fluidically downstream thereof and, by swirling, expands the fluid to be homogenized which has previously been brought to a pressure of more than 500 bar in the high pressure chamber, and a plunger pump associated with the homogenizer unit, the plunger of which plunger pump pressurizes the high pressure chamber, wherein the high pressure homogenizer has a low pressure chamber which surrounds the plunger shaft to cool the plunger and which has an operating pressure of PN≤25 bar, wherein the low pressure chamber and the high pressure chamber are separated from each other by a seal which is penetrated by the plunger, wherein the seal is a throttle gap which is formed between the plunger shaft and a bushing that does not contact the plunger shaft, the ratio S/L of the length to the radial annular gap height of the throttle gap being ≤0.0015.

2. The high pressure homogenizer for fluid substances according to claim 1, wherein the cylindrical length of the throttle gap is equal to at least ⅔ of the diameter of the plunger and ideally corresponds at least to the entire diameter of the plunger.

3. The high pressure homogenizer for fluid substances according to claim 1, wherein the annular gap height of the throttle gap is equal to a maximum of 0.03 mm.

4. The high pressure homogenizer for fluid substances according to claim 1, wherein the front end of the bushing on its side facing the high pressure chamber leads by way of a bevel to the inner enclosing surface of the bushing and the bevel is configured preferably as a flat bevel with a bevel angle of 30 degrees or less.

5. The high pressure homogenizer for fluid substances according to claim 1, wherein the front end of the bushing on its side facing the high pressure chamber leads by way of a bevel to the internal enclosing surface of the bushing and that the bevel, on its side facing the high pressure chamber, consists of a first, steeper bevel portion, which preferably forms approximately a bevel angle of 45 degrees to the longitudinal axis of the bushing, to which, on the side facing the seal gap, a second bevel portion is connected, having a flatter bevel angle of 30 degrees or less.

6. The high pressure homogenizer for fluid substances according to claim 1, wherein the bushing and the plunger are constructed of materials with different heat expansion coefficients.

7. The high pressure homogenizer for fluid substances according to claim 1, wherein the plunger is constructed of ceramic material.

8. The high pressure homogenizer for fluid substances according to claim 1, wherein the material of the bushing is softer than the material of the plunger.

9. The high pressure homogenizer for fluid substances according to claim 1, wherein the plunger is configured in such a way that the longitudinal axes of the bushing and of the plunger shaft moving back and forth in the bushing are consistently aligned parallel or preferably coaxially, wherein the plunger at the same time is the drive piston or wherein the drive piston and the plunger are guided in their connection area while fixed to the housing.

10. The high pressure homogenizer for fluid substances according to claim 1, wherein the bushing is held in the radial direction essentially rigid in the housing portion surrounding it and the plunger—by means of a radially flexible coupling that prevents transmission of pivotal motions from the drive piston onto the plunger—is connected with the drive piston that powers it.

11. The high pressure homogenizer for fluid substances according to claim 1, wherein the bushing is held in the radial direction more than to an insignificant extent in the housing portion surrounding it and the plunger in the radial direction is connected rigidly with the drive piston that powers it.

12. The high pressure homogenizer for fluid substances according to claim 10, wherein the front end of the plunger on the drive side or the front end of the drive piston transmitting drive pressure forces onto them is curved convexly.

13. The high pressure homogenizer for fluid substances according to claim 1, wherein the bushing is configured of numerous parts and consists of several rings, ideally of three, or better of at least four to eight rings, which are built in, one directly after the other and in direct contact with one another.

14. The high pressure homogenizer for fluid substances according to claim 1, wherein either the bushing which is directly involved in the configuration of the seal gap is mounted floating in its entirety, preferably by being equipped on its outer enclosure—at least in part, better completely—with a bearing sleeve made of more than only insignificantly compressible material, ideally of a soft elastomer or rubber, or that the rings configuring the bushing are each mounted in floating manner on its own, preferably having a bearing sleeve made of more than insignificantly compressible material on its outer periphery—at least partly, better completely.

15. The high pressure homogenizer for fluid substances according to claim 1, wherein the outer enclosing surface of the bushing is spherical rather than ideally cylindrical.

16. A use of a high pressure homogenizer for fluid substances charged with particles, having a high pressure chamber and a homogenizer unit that is located fluidically downstream thereof and, by swirling, expands the fluid to be homogenized which has previously been brought to a pressure of more than 500 bar in the high pressure chamber, and a plunger pump associated with the homogenizer unit, the plunger of which plunger pump pressurizes the high pressure chamber, wherein the high pressure homogenizer has a low pressure chamber which surrounds the plunger shaft to cool the plunger and which has an operating pressure of PN≤25 bar, wherein the low pressure chambr and the high pressure chamber are separated from each other by a seal which is penetrated by the plunger, wherein the seal is a throttle gap which is formed between the plunger shaft and a bushing that does not contact the plunger shaft, the ratio S/L of the length to the radial annular gap height of the throttle gap being ≤0.00015,
wherein the front end of the bushing on its side facing the high pressure chamber leads by way of a bevel to the internal enclosing surface of the bushing and that the bevel, on its side facing the high pressure chamber, consists of a first sleeper bevel portion which preferably forms approximately a bevel angle of 45 degrees to the longitudinal axis of the bushing, to which, on the side facing the seal gap, a second bevel portion is connected, having a flatter bevel angle of 30 degrees or less, wherein the use is configured in such a way that the materials of the bushing and plunger are adapted to the fluid that is to be homogenized, in particular to its temperature-dependent viscosity and/or to the particles carried by the fluid, in such a way that the modification of the gap height of the seal gap caused by a temperature change in the seal gap area tends to counteract yet another temperature change with the same identifying name.

17. The use of a high pressure homogenizer according to claim 14 as a component of a high pressure homogenizer system which consists of such a high pressure homogenizer and a set of bushings of diverse materials, by means of which the user can equip the high pressure homogenizer in the framework of the prescribed operation in such a way that the thermal conduct modifications of the gap height can be adjusted to the fluid that is intended to be homogenized in the current assignment or process.
